(19) United States
(12) Patent Application Publication
(10) Pub. No.: US 2015/0339030 A1
(43) Pub. Date: Nov. 26, 2015

(54) METHOD, APPARATUS, AND SYSTEM FOR DATA TRANSFER ACROSS APPLICATIONS

(71) Applicant: Alibaba Group Holding Limited, George Town (KY)

(72) Inventors: Zhijun Yuan, Hangzhou (CN); Xiaodan Dai, Hangzhou (CN)

(21) Appl. No.: 14/716,698

(22) Filed: May 19, 2015

(30) Foreign Application Priority Data
May 22, 2014 (CN) 201410219459.0

(51) Int. Cl. G06F 3/0481; G06F 9/54; G06F 3/0486; G06F 3/0482; G06F 3/0484

(52) U.S. Cl. CPC G06F 3/04817; G06F 3/0482; G06F 3/04842; G06F 3/0486; G06F 9/542

(57) ABSTRACT

Embodiments of the present application relate to a method, apparatus, and system for transferring data between applications. The method includes, in response to receiving an operating system interface call out message, providing an interface of an operating system running on a device, in response to a data access interface conforming to a first preset standard definition being invoked, receiving a data entity associated with a first application installed on the device, and in response to a data access interface of a second application being invoked, writing the data entity into the second application.

### CROSS REFERENCE TO OTHER APPLICATIONS

This application claims priority to People's Republic of China Patent Application No. 201410219459.0 entitled A DATA TRANSFER METHOD AND DEVICE, filed May 22, 2014 which is incorporated herein by reference for all purposes.

### FIELD OF THE INVENTION

The present application relates to a field of data processing. In particular, the present application relates to a method, a device, and a system for data transfer.

### BACKGROUND OF THE INVENTION

As mobile phones, computers, and other terminals become widespread, an increasing number and variety of applications (apps) are being developed and installed on terminals. The applications have brought a great deal of convenience to users' lives.

The apps generally use functions that the apps themselves provide to obtain data entities from external data sources and to display the data entities through various views. Data entities are vehicles for carrying various kinds of information (e.g., between the terminal and a web server). Because different apps vary with respect to use scenarios, forms of interaction, and other aspects, data may be subject to different input requirements or presentation forms in different apps even if the type or content of data is the same. The specific input requirements or presentation forms associated with a particular app are related to the functions provided by the particular app. If a user wishes to have data from one app according to some related art appear in another app according to some related art in another form of presentation, the user is generally required to start the other app and manually enter the data therein. For example, assuming that an e-commerce or marketplace app (e.g., a Taobao app) associated with travel provides a ticket ordering function, the e-commerce or marketplace app can display trip information (e.g., departure time, arrival time, departure city, arrival city, and other such information) after the user has ordered an airplane ticket. If a user wishes to view alerts for the trip in a calendar app using a card view of the calendar app, the user is generally required to manually re-enter the trip information in the calendar app in accordance with the input requirements of the calendar app.

However, requiring users to re-enter existing data within a first application in accordance with the input requirements of a second application is inconvenient. Therefore, there is a need for a method, device, and system for providing data transfer.

### BRIEF DESCRIPTION OF THE DRAWINGS

Various embodiments of the invention are disclosed in the following detailed description and the accompanying drawings.

In order to provide a clearer explanation of the technical solutions in the prior art or in embodiments of the present application, simple introductions are given below to the drawings which are needed for the embodiments or the prior art. Obviously, the drawings described below are merely some embodiments recorded in the present application. Persons with ordinary skill in the art could, without expending creative effort, obtain other drawings on the basis of these drawings.

FIG. 1 is a flowchart of a data transfer method according to various embodiments of the present application.

FIG. 2 is a flowchart of a data transfer method according to various embodiments of the present application.

FIG. 3 is a diagram of an application interface provided by an embodiment of the present application.

FIG. 4 is a diagram of an operating system interface according to various embodiments of the present application.

FIG. 5 is a diagram of an application icon according to various embodiments of the present application.

FIG. 6 is a diagram of a data entity according to various embodiments of the present application.

FIG. 7 is a block diagram of a data transfer device according to various embodiments of the present application.

FIG. 8 is a structural block diagram of a system for providing data transfer between applications according to various embodiments of the present application.

FIG. 9 is a functional diagram of a computer system for providing data transfer between applications according to various embodiments of the present application.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

Transfer of data between different applications is inconvenient in the conventional related art. Various embodiments relate to a method, device, and/or system that provides data transfer between or across different applications that is intuitive for a user. Various embodiments provide a method, an apparatus, and a system for displaying data entities in a card view. According to various embodiments, enabling a user to transfer corresponding data entities between applications by dragging card views in a visual manner makes user operations more convenient.

In some embodiments, the data transfer method is applied to an operating system. A data access interface conforming to a first preset standard definition in the operating system can be predefined. Applications can perform read/write operations on storage areas of the operating system by invoking the data access interface. The specific content of the first preset standard definition is not limited. For example, the preset standard definition can be defined as needed for actual application scenarios.

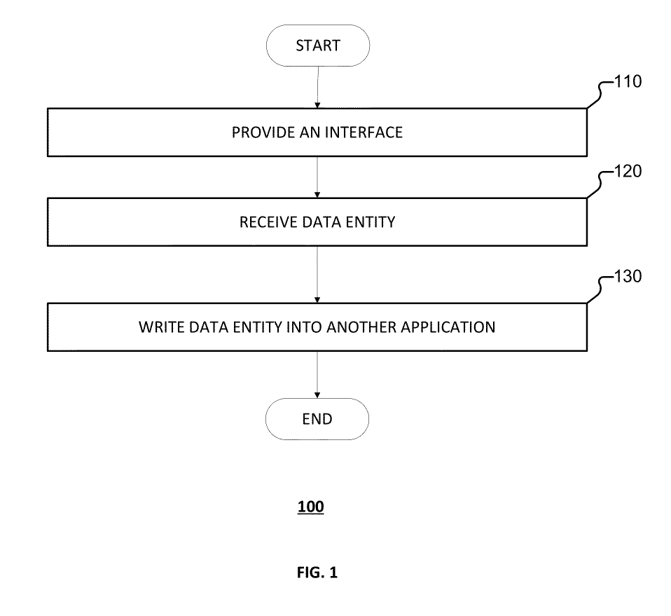

FIG. 1 is a flowchart of a data transfer method according to various embodiments of the present application.

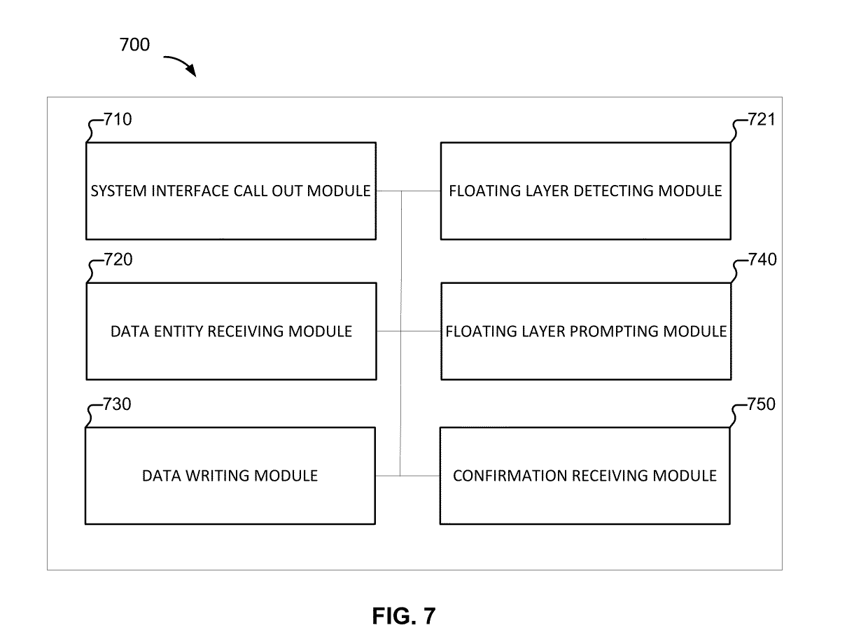

Referring to FIG. 1, a method 100 for data transfer is provided. In some embodiments, process 100 is implemented by device 700 of FIG. 7. Other implementations are possible.

At 110, an interface is provided. In some embodiments, the interface corresponds to a user interface of an operating system executing on the device, such as a desktop and/or any additional display layer associated with the device. The interface of the operating system can be provided (e.g., displayed) in response to a device (e.g., an operating system running on the device) receiving an operating system interface call out message issued by a first application.

The operating system can correspond to various operating systems such as Windows, iOS, Android, Chrome, Linux, Tizen, or the like. The operating system can be a single-tasking operating system, a multi-tasking operating system, a single user operating system, a multiple user operating system, a distributed operating system, a templated operating system, an embedded operating system, a real-time operating system, the like, or any combination thereof.

The operating system can receive the first application-issued message (e.g., the operating system interface call out message issued by the first application) according to a message handling mechanism provided by the operating system. For example, the operating system can be an Android operating system, and the first application-issued operating system interface call out message that is received by the operating system can be an Intent message carrying a desktop call out instruction. In other operating systems, different message handling mechanisms may be used.

In some embodiments, the operating system interface call out message is specifically sent from (e.g., issued by) the first application in the event that the first card view of the first application (e.g., a first CardView object displaying the user interface of the first application) has a selected status. The card view can be a view in which an object that displays a representation of a data entity is provided. For example, the card view can include an icon or other image that represents the data entity. As an example, in the event that the data entity is a plane ticket, the card view can include an image or icon on which a representation of the plane ticket (e.g., the plane ticket having a reduced size relative to an original size) is provided. For example, in response to the first card view being selected in the first application, the first application can issue the operating interface call out message. In some embodiments, there is no restriction on the specific implementations whereby the first card view has a selected status. For example, a first card view long click (e.g., a lingering touch and press of the first card view user interface) can cause the first card view to have a selected status. A long click can be a click that is engaged for at least a threshold period of time. As an example, a long click can correspond to a touch on a touchscreen such that the touch is maintained for at least the threshold period of time (e.g., 2 seconds). In the event that a user long clicks a first card view in the first application, the first application can correspondingly issue a message to the operating system to call out the operating system interface (or the system desktop) (e.g., to invoke and display the operating system interface or the system desktop). The operating system can thus receive the message to call out the operating system interface that was issued by the first application and present the system desktop.

In some embodiments, the first card view corresponds to a data entity. For example, the first CardView object stores data associated with the data entity in the object's attributes.

At 120, a data entity is received by the operating system. The operating system can receive the data entity from the first application in response to the first application invoking the data access interface. In some embodiments, the data entity is written by the first application invoking the data access interface (e.g., an interface through which an API can access data) conforming to a first preset standard definition. The preset standard definition can correspond to a data definition. The data access interface can correspond to an interface of a particular application by which another application or operating system can access data stored in the particular application. The data entity can correspond to the first card view. The data entity can be provided on the operating system interface. The operating system interface can correspond to an interface with which a user or an application can interact or communicate with the operating system. For example, the operating system can be a user interface that displays a plurality of icons respectively associated with an application or a data entity. The operating system interface can receive a data entity from an application, or can provide a data entity that the operating system has retrieved from the application (e.g., via a data access interface of the application). As example, in response to the data entity being received in the event that the first application invokes the data access interface, the operating system interface can provide a second view displaying the data entity. The second view can correspond to a display of a background or desktop that includes the data entity or a representation of the data entity. The second view can display the data entity as a selectable icon or object on a user interface. In some embodiments, the second view corresponds to a card view.

In some embodiments, before the first application issues an invocation to the data access interface, the first application can read the data entity from the location that the first application uses to store data entities corresponding to the first card view and can issue a data access interface invocation to the operating system. For example, if the operating system is an Android operating system, then the first application can invoke an Android operating system provider interface that conforms to a first preset standard definition.

Various embodiments are not limited as to the pattern of the second view presented on the operating system interface or as to the time that the second view is generated.

In some embodiments, a card view is generated on the operating system interface. Specifically, a CardView object can be generated and displayed. The card view can correspond to the second view in which the data entity is displayed. The card view can be generated on the operating system after the interface of the operating system is presented. For example, the card view can be generated on the operating system directly after the interface of the operating system is presented. In some embodiments, a user of the device (e.g., the device on which the operating system is running) can select the time and location at which the card view is generated. In order to enable the user to select the time and location that the card view is generated, the first application can create a floating layer (e.g., a window overlaid on top of the first card view) in response to selection of the first card view. The first application can create the floating layer before a card view is generated on the operating system interface. An image can be drawn on the floating layer according to said first card view. In some embodiments, in the event that the operating system interface is presented, the floating layer can float with a selected status (e.g., a status indicating that the floating layer is selected) on the operating system interface. For example, in the event that the operating system interface is presented, the floating layer can automatically float with a selected status on the operating system interface such that the floating layer can be dragged. The floating layer can be dragged so as to change the location at which the floating layer is presented in relation to the operating system interface. The floating layer can be selected, which results in the floating layer having a selected status. The floating layer can also be de-selected, which results in the floating layer having a released status. The floating layer can be selected by a user, the operating system, or an application. In the event that the operating system detects that the status of the floating layer changed from selected to released, the operating system can generate a card view according to one or more of the display patterns of the floating layer at the location of the floating layer on the operating system interface, the location of the floating layer on the operating system interface, or the like. The receiving of the data entity written by the first application invoking the data access interface conforming to the first preset standard definition and the generating of a card view on the operating system interface can be performed in various orders or concurrently.

In some embodiments, the floating layer created by the first application in the event that the first card view is selected is presented on the operating system interface. For example, the floating layer can be created by the first application in response to the selection of the first card view. In some embodiments, the floating layer includes an image drawn thereon (or embedded therein) by the first application according to the display pattern of the first card view. The first application can generate the image included with the floating layer, or the first application can retrieve the image from a storage. In the event that the operating system interface is presented, the floating layer can float (e.g., be displayed in a top layer) with a selected status on the operating system interface. For example, in the event that the operating system interface is presented, the floating layer can automatically float with a selected status on the operating system interface such that the floating layer can be dragged. The floating layer can be dragged so as to change the location at which the floating layer is presented in relation to the operating system interface. The floating layer can be selected, which results in the floating layer having a selected status, or de-selected, which results in the floating layer having a released status. The floating layer can be selected by a user, the operating system, or an application. In some embodiments, the first card view displays a data entity, and an image is drawn on (or embedded in, or otherwise included with) the floating layer. The first card view can display the data entity, and the image can be drawn on (or embedded in, or otherwise included with) the floating layer according to the display pattern of the first card image. Accordingly, in some embodiments, the floating layer can be used to display the data entity.

At 130, the data entity is written into another application. In some embodiments, the data entity received at 120 can be written in, or otherwise associated with, another application. For example, in response to the second view being dragged on the operating system interface to the location of an icon of a second application, the data access interface of the second application is invoked to write the data entity into the second application. The data access interface of the second application can conform to a second preset standard definition. The writing of the data entity into the second application can include copying the data entity into a specific storage or memory location known to the second application, providing a link or pointer to the data entity in the second application, or otherwise associating the data entity with the second application.

The second application can be represented on the operating system interface as an icon or the like. In the event that the second view is dragged on the operating system interface, the second application can be an application corresponding to any icon on the operating system interface that is in proximity to the path passed by dragging the second view. In some embodiments, the second application corresponds to the application associated with the icon over which the second view is released from being dragged.

In some embodiments, some applications can provide a data access interface that conforms to a second preset standard definition and some applications cannot provide a data access interface that conforms to a second preset standard definition. A preset standard definition can correspond to a set of defined variables or definitions that provide a standardized mechanism for interfacing with an application that conforms to the definition. For example, the preset standard definition can define how data is stored in the application (e.g., format, name, or location), or the like. The preset standard definition can be a data definition. According to some embodiments, in order to avoid writing data to an application that does not provide a data access interface with a second preset standard definition (which can cause a program run error), a determination can be made as to whether the second application has provided a data access interface that conforms to the second preset standard definition. The operating system can determine whether the second application has provided a data access that conforms to the second preset standard definition. For example, in the event that the second view is dragged on the operating system interface to the location of an icon representing the second application, then the determination of whether the second application has provided a data access interface that conforms to the second preset standard definition can be made. In some embodiments, the determination of whether the second application has provided a data access interface that conforms to the second preset standard definition can be made by an application (e.g., the first application) or the operating system. As an example, the first application or the operating system can detect whether the second application has provided a data access interface that conforms to the second preset standard definition by checking registry entries or the like. In the event that the second application has provided a data access interface that conforms to the second preset standard definition, then the data access interface (of the second application) that conforms to the second preset standard definition is invoked to write the data entity into the second application. In some embodiments, the second application invokes the data access interface in response to an indication (e.g., provided by the operating system or the like) that the second view is dragged on the operating system interface to the location of an icon of the second application. In some embodiments, the operating system invokes the data access interface of the second application to write the data entity into the second application. The operating system can invoke the data access interface of the second application to write the data entity into the second application in response to the second view being dragged on the operating system interface to the location of an icon of the second application and the determining that the second application has provided a data access interface that conforms to the second preset standard definition. The data access interfaces and other such information provided by, or otherwise associated with, applications will be disclosed in the relevant registration information of the operating system (e.g., in specific registry entries). The operating system can use the information disclosed in the relevant registration information of the operating system to determine whether the second application has provided a data access interface that conforms to the second preset standard definition. In some embodiments, the operating system can determine whether an application has provided a data access interface that conforms to a second preset standard definition based on (e.g., using) the relevant registration information associated with the application. For example, if the operating system is an Android operating system, the data access interface (of the second application) conforming to a second preset standard definition can be a provider interface that conforms to a second preset standard definition and that is provided by the second application. In some embodiments, the content of the second preset standard definition is not restricted. For example, the content of the second preset standard definition can be defined as needed for actual application implementations. The first preset standard definition and the second preset standard definition of the present application can be the same or can be different. In some embodiments, the first preset standard definition and the second preset standard definition are defined in the same way. For example, the first preset standard definition and the second preset standard definition are the same definition. In other words, the operating system and the second application that can receive transferred data entities provide data access interfaces that are defined as the same.

In some embodiments, a prompt can be provided to the user. For example, the prompt can be provided while the second view is being dragged. A corresponding prompt can be provided during the process of the user dragging the second view to make users accurately transfer data entities into applications that can receive the data entities. The prompt can provide an indication of whether the data entity can be written to the second application. For example, the prompt can be provided in relation to an application corresponding to an icon over which the second view being dragged is concurrently over. As an example, in the event that the second view has been dragged on the operating system interface to the location of an icon of a second application, and the second application has provided a data access interface conforming to a second preset standard definition, then a floating layer can be provided on the operating system interface (e.g., the floating layer may be presented at the location of an icon of the second application). The floating layer can include a prompt. For example, prompt information can be displayed on the floating layer and can indicate that the second application can accept the writing of a data entity. In the event that an indication confirming the writing of a data entity into the second application is received, the data access interface of the second application and that conforms to a second preset standard definition can be invoked. The indication that confirms the writing of a data entity into the second application can correspond to a prompt provided to the user (e.g., on a floating layer), a change of color of the icon associated with the second application, a vibration, an indicator light, or the like. The data access interface of the second application can be invoked to write the data entity into the second application. The message confirming the writing of a data entity that can correspond to an instruction confirming the writing of the data entity into the second application is received. The operating system can create an instruction confirming the writing of the data entity into the second application in response to the user providing an input that confirms a desire to write the data entity into the second application. In the event that no message confirming the writing of a data entity into the second application is received, and the second view is dragged away from the location of the icon of the second application, the floating layer may be deleted (e.g., removed). The message confirming the writing of a data entity into the second application can be configured according to various forms. For example, the message can be generated by an event such as the releasing of the floating layer.

In response to the event of the second view being dragged on the operating system interface (e.g., the second view being dragged by the user using a finger, a mouse, or other pointing device), the dragging of the second view can be monitored. For example, the dragging can be monitored to determine whether the second view is dragged to the location of an icon of the second application. As an example, in response to the second view being dragged (e.g., in response to a generated card view on the operating system interface or in response to a floating layer for displaying a data entity being dragged on the operating system interface), the coordinates of the dragged second view on the operating system interface (e.g., the pixel locations of pixels in the second view) can be compared with the coordinates of an icon of an application (e.g., the pixel locations of pixels in the icon) on the operating system interface during the dragging process. The coordinates of the dragged second view on the operating system interface can be continuously compared with the coordinates of an icon of an application on the operating system interface during the dragging process. The comparison results (e.g., the results of the comparison of the coordinates of the dragged second view on the operating system interface with the coordinates of an icon of an application on the operating system interface during the dragging process) are used as a basis for determining whether the dragged second view has been dragged to the location of the icon of the second application. In the event that the dragged second view has been determined to have been dragged to the location of the icon of the second application based on the comparison results, the second view is confirmed to have been dragged on the operating system interface to the location of the icon of the second application.

In some embodiments, after the data entity is written into the second application, there are no restrictions as to the ways in which the second application stores, processes, and displays said data entity. For example, the second application can have autonomy to process, store, and use the data entity such that the first application does not restrict the processing, storing, or using of the data entity by the second application. Specifically, the processing, storing, and using of the data entity are related to the functions provided by the business services of the second application or other functions of the second application. For example, in the event that the data entity is written into the second application, the second application can, in response to the writing of the data entity into the second application, generate within the second application another card view that conforms to the needs or requirements of the second application that are associated with displaying the data entity. In the event that the second application is launched (e.g., executed), another card view of the data entity can be displayed on the second application interface.

In some embodiments, the operating system can receive a data entity written in by a first application at the location of a first card view because a data access interface conforming to a first preset standard definition is provided in the operating system. Moreover, because a second view displaying the data entity is presented on the operating system interface, the user can drag the second view to the location of the icon of a second application. The operating system, responding to a user operation, can invoke a data access interface conforming to a second preset standard definition to write a data entity into the second application and thus cause the data entity to be transferred (e.g., copied) into the second application. Consequently, the operating system may serve as a bridge for transferring data in that a user completes the transfer of a data entity between applications by dragging the view corresponding to the data entity.

In some embodiments, a data entity can be transferred to a background (e.g., a background displayed by the operating system). The data entity can be copied from the first application to the background. Accordingly, in some embodiments, in addition to being able to perform the transfer of a data entity between applications in response to a dragging of the view corresponding to the data entity, data entities can be transferred directly in the background. For example, in response to receiving the data entity written by the first application invoking the data access interface conforming to a first preset standard definition, any application can be selected in response to an operation other than dragging the second view. For example, a user can select any application by clicking the icon of that particular application displayed on the operating system interface. If the selected application provides a data access interface conforming to a second preset standard definition, then the data entity is written into the selected application by invoking the data access interface.

In the following example, the operating system running in the terminal is an Android operating system, the first application is a Taobao client app, and the second application is a calendar app. In this application scenario, various embodiments are described in detail in terms of possible implementations whereby a user completes the transfer of a data entity between applications by dragging the view corresponding to the data entity.

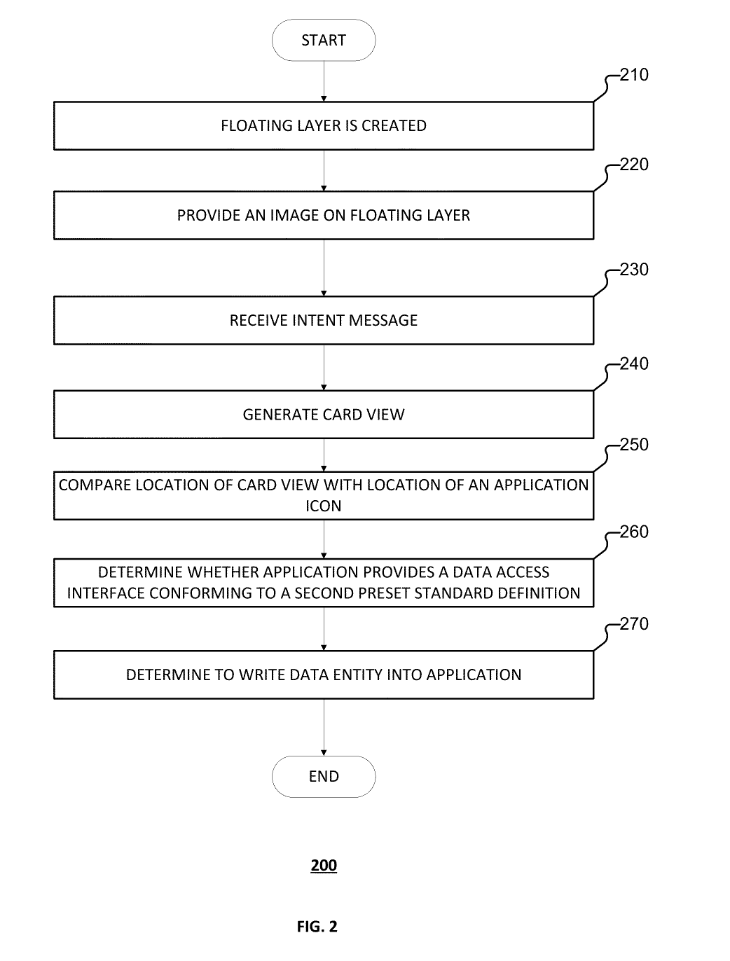

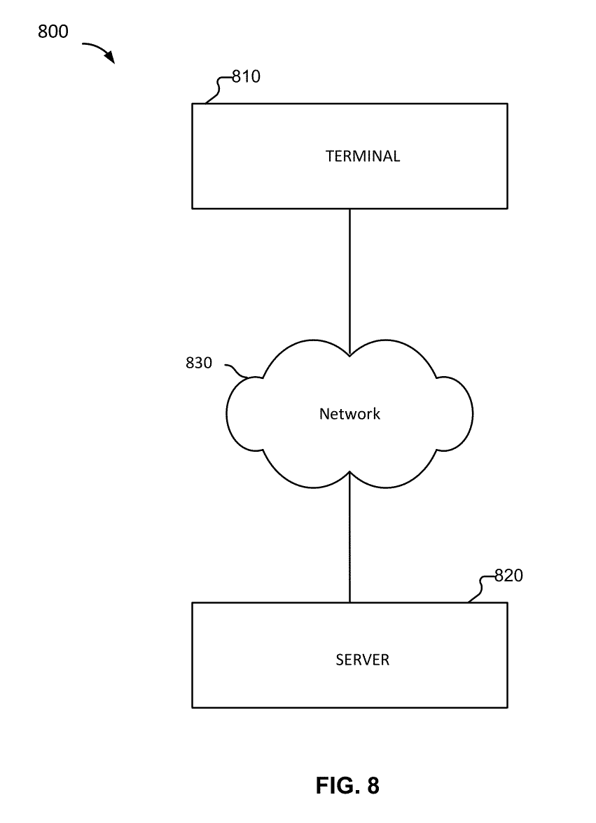

FIG. 2 is a flowchart of a data transfer process according to various embodiments of the present application. Process 200 can be performed by a system such as 800 of FIG. 8.

At 210, a floating layer is created. In some embodiments, the floating layer is created by the operating system. For example, the operating system can create the floating layer in response to a user input. The user input can correspond to a long click of a card view to select the card view object.

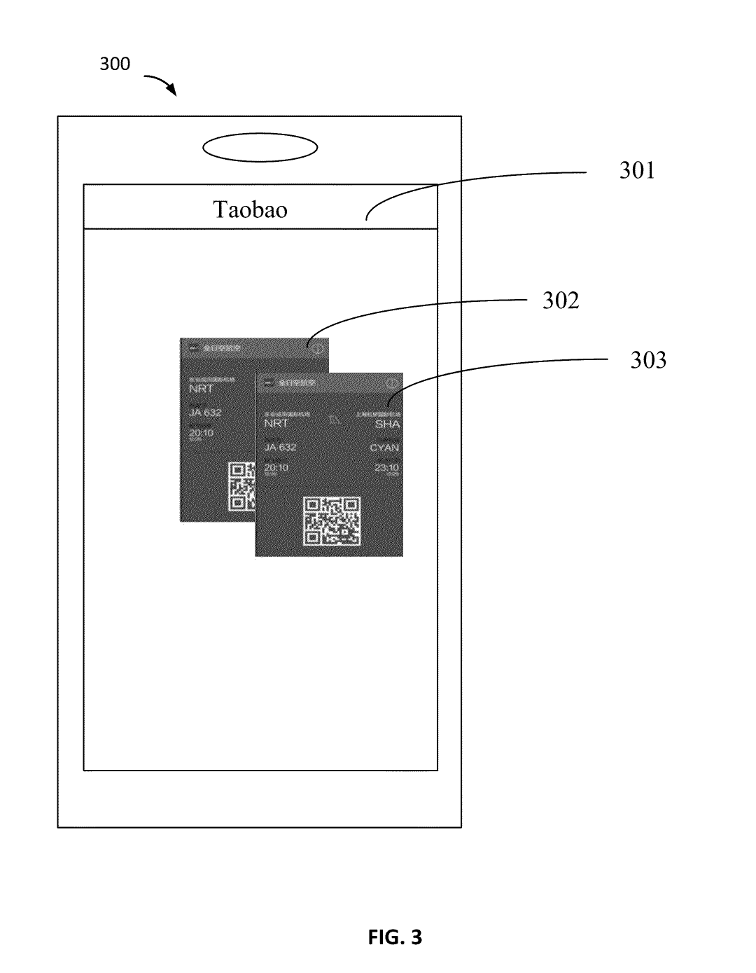

FIG. 3 is a diagram of a Taobao application interface provided by an embodiment of the present application.

Referring to FIG. 3, an application interface 300 used in connection with data transfer is provided.

In some embodiments, the application interface 300 includes an interface of an application 301 (e.g., a client application), a card view 302, and a floating layer 303. The card view 302 can correspond to a mobile phone card view in the event that the device on which the interface 300 is displayed corresponds to a mobile device. In other words, the mobile phone card view can correspond to a card view in the event that the device on which the interface 300 is displayed is a mobile device.

In response to the user providing a predefined input (e.g., long clicking) to the card view 302 in the application (e.g., a Taobao client), the application creates the floating layer 303. In some embodiments, the application creates the floating layer 303 by instantiating a Canvas class. In some embodiments, the Canvas class corresponds to a class used for drawing provided in an operating system such as the Android operating system. The floating layer can include a representation of the card view 302.

At 220, an image is provided on the floating layer. In some embodiments, the application (e.g., the Taobao client app) provides the image on the floating layer 303. For example, the application can draw an image based at least in part on a pattern of the card view 302 on the floating layer. The pattern of the card view 302 that can form a basis for the image provided on the floating layer 303 can include dimensions of the card view 302, an image included in the card view 302, information provided in the card view 302, the like, or any combination thereof. In some embodiments, the application sends to the operating system an Intent message to call out (e.g., request) the operating system interface. The application can send the operating system the Intent message to call out the operating system interface in the event that the application provides the image on the floating layer 303.

For example, the drawing of an image according to the pattern of the card view 302 on the floating layer 303 can be implemented using the following program code segments:

```
  public Bitmap createDragBitmap(View v, Canvas, int padding) {
  Bitmap b;
    if (v instanceof TextView) {
        Drawable d = ((TextView) v).getCompoundDrawables( )[1];
        b = Bitmap. createBitmap(d.getIntrinsicWidth( ) + padding,
          d.getIntrinsicHeight( ) + padding, Bitmap.Config.ARGB_8888);
    } else {
        b = Bitmap. createBitmap(v.getWidth( ) + padding, v.get
        Height( ) + padding,
Bitmap.Config.ARGB_8888 ); }
        canvas.setBitmap(b);
      drawDragView(v, canvas, padding, true);
      canvas.setBitmap( null);
      return b; }
```

At 230, an Intent message is received. In some embodiments, the operating system receives the Intent message from the application (e.g., the application in which the floating layer is created and populated with the image). The Intent message can correspond to a message to call out the operating system interface.

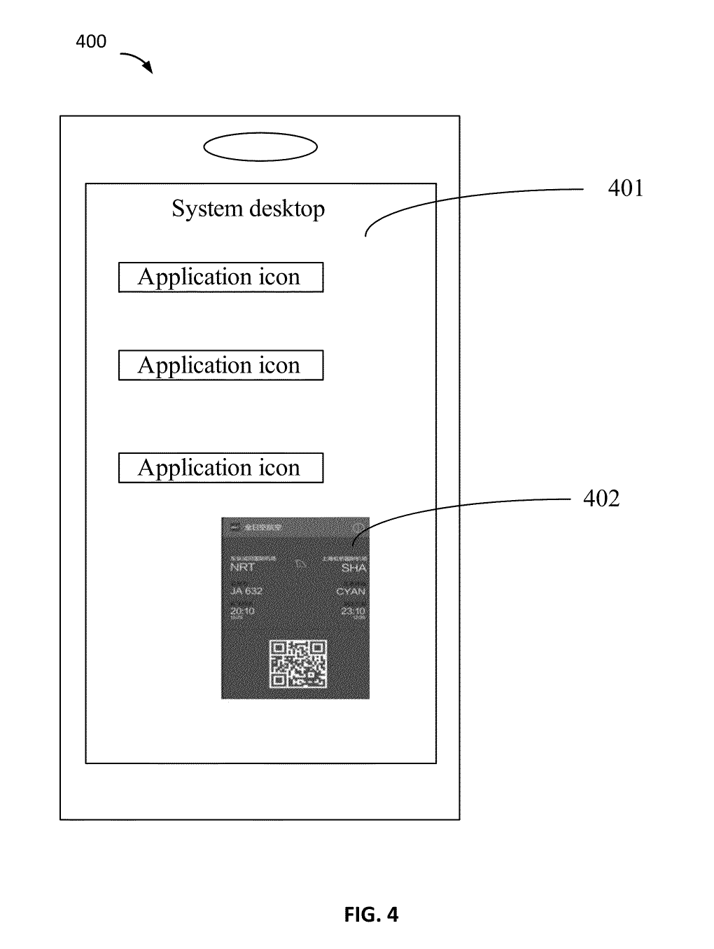

FIG. 4 is a diagram of an example operating system interface according to various embodiments of the present application.

In some embodiments, the operating system interface 400 includes a system desktop 401 and a floating layer 402. In some embodiments, the floating layer 402 can correspond to the floating layer 303 that is created in response to a user input associated with the data transfer (e.g., across applications). For example, the user input can correspond to a long click on the data entity to be transferred.

In the event that the operating system receives the Intent message from the application (e.g., the Taobao client app), the operating system accordingly presents the system desktop 401 of the operating system. The floating layer 402 can display the data entity (e.g., the data entity to be transferred). The floating layer 402 that displays the data entity floats on the system desktop 401. For example, the floating layer 402 can float on the system desktop 401 such that the floating layer 402 can be dragged by the user. In the event that the floating layer 402 is dragged by the user, the positioning of the floating layer 402 (or the data entity included in the floating layer 402) can be moved relative to the system desktop 401.

For example, the sending of the Intent message by the application (e.g., the Taobao client app) to invoke the desktop can be implemented using the program code segments below. The code segments below can set or otherwise initiate parameters used to send the Intent message by the application.

Intent i = new Intent(Intent. ACTION_MAIN);
i.setFlags(Intent. FLAG_ACTIVITY_NEW_TASK);
i.addCategory(Intent. CATEGORY_HOME);
startActivity(i);

At 240, a card view is generated. In some embodiments, the operating system generates the card view. The card view can be generated in the event that the floating layer displaying, or otherwise including, the data entity is dragged and released (or when the dragging stops for a threshold period of time).

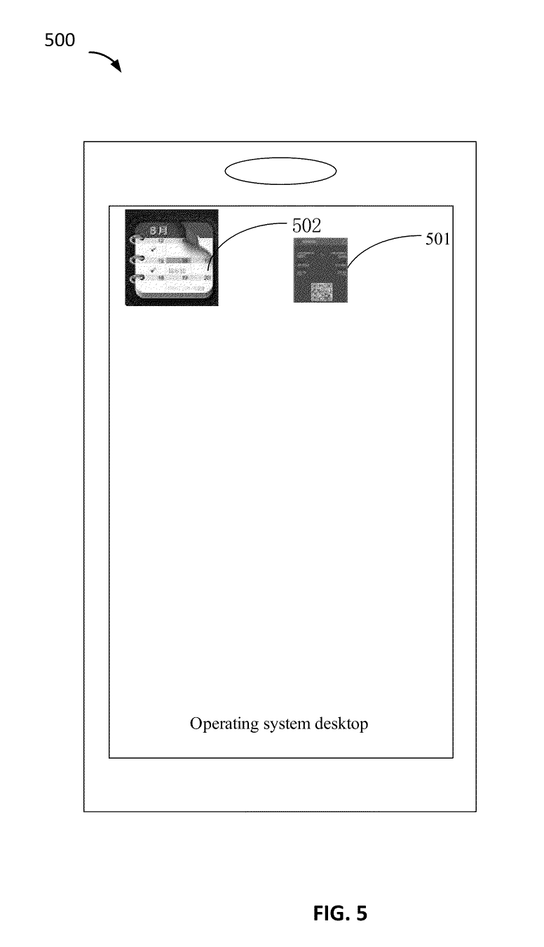

FIG. 5 is a diagram of an example application icon according to various embodiments of the present application.

In some embodiments, the operating system interface 500 includes a card view 501 and an application icon 502. The application icon 502 can correspond to a calendar application installed on the device. In some embodiments, the card view 501 includes a representation of the data entity (e.g., the data entity associated with the request to transfer data).

In response to the user dragging the floating layer displaying the data entity onto the operating system interface, in the event that the user stops the dragging and releases the floating layer, the operating system generates the card view 501. The operating system can generate the card view 501 at the location of the floating layer on the operating system interface. For example, the card view 501 can be generated at the location at which the dragging of the floating layer was released. Moreover, the operating system receives the data entity written by the application (e.g., the Taobao client app) invoking the data access interface conforming to a first preset standard definition. The card view 501 can display the written data entity. For example, the card view 501 can include a representation of the written data entity. The representation of the written data entity can be an image of the written data entity.

In this example, the data entity relates to an airplane reservation (e.g., an airplane ticket), the display pattern of the generated airplane ticket card view 501 can be displayed on the basis of the display pattern of the image on the floating layer. The written data entity corresponding to the airplane ticket card view 302 can be the data entity.

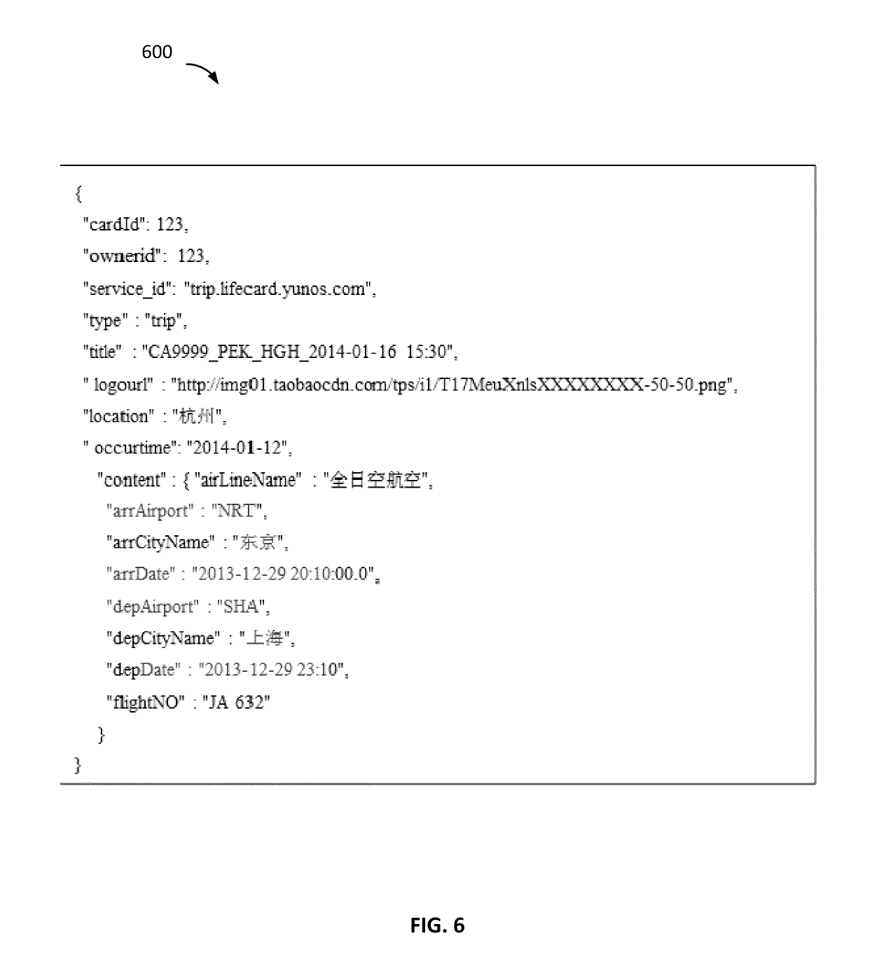

FIG. 6 is a diagram of an example data entity according to various embodiments of the present application.

Referring to FIG. 6, a data entity 600 that can be transferred across (between) applications installed on a device is provided.

In some embodiments, from the perspective of program code implementation, the invocation by the application (e.g., the Taobao client app) of the provider of the operating system to write the data entity into the operating system is implemented through the following program code: ContentResolver.insert(insertUri, values), wherein “insertUri” represents the address at which the data entity is written (e.g., address: content:// yunos.lifecard.com/cards), and “values” represents content conforming to a first preset standard definition and including the data entity that is to be written. The first preset standard definition can require a variety of values and be defined according to the application needs. In one example, the first preset standard definition can require that values include the following variables or information:

```
{
″sid″// card view identifier corresponding to the server
  ″service_id″// ISV service identifier
  ″ownerid″// owner of card view
  ″title″// card view title
  ″content″// content to be displayed by card view
  ″occurtime″ // time of card view creation
  ″gmtexpired″ // card view expiration time
  ″location″ // location of card view
  ″logourl″ // logo address in card view
}
```

In some embodiments, the card view corresponding to the data entity can be dragged to the desktop, the card view can be released, and the data entity in the operating system can be stored. For example, the card view corresponding to the data entity can be dragged, released, and stored in the event that a user provides an input to the device in connection with dragging the card view corresponding to the data entity in the application (e.g., the Taobao client app). In some embodiments, the user can drag, display, and perform other such operations on the card view corresponding to the data entity on the operating system interface.

At 250, the location of the card view 501 is compared with the location of an application icon. In some embodiments, the operating system compares the location of the card view 501 with the application icon. For example, in response to the operation of the user dragging the card view 501, the operating system can compare the coordinates of the card view 501 with the coordinates of all application icons on the operating system interface. Specifically, in some embodiments, the pixel location of the center pixel of the card view is compared with the pixel locations of the center pixels of the application icons for all the applications on the operating system interface to determine distances of the card view area to the application icons. In some embodiments, pixel locations of the card view are compared with pixel locations of each application icon to determine whether any portion of the card view and each application icon overlap. The operating system can continually (or at preset time intervals) compare the coordinates of the card view 501 with the coordinates of all application icons on the operating system interface during the process of dragging the card view 501. The comparison results (e.g., the results of the comparison of the coordinates of the dragged second view on the operating system interface with the coordinates of an icon of an application on the operating system interface during the dragging process) are used as a basis for determining whether the card view 501 was dragged to the location of any application icon. In some embodiments, if a portion of the card view 501 overlaps with the location of an application icon (e.g., if the distance between the center pixel of the card view and an application icon pixel is below a certain threshold, or if any pixel of the card view is the same as an application icon), then the card view 501 can be deemed to be dragged to the location of the application icon. At 260, a determination is made as to whether an application provides a data access interface that conforms to a second preset standard definition. In some embodiments, the operating system determines whether the application provides the data access interface that conforms to the second preset standard definition. In some embodiments, an application can register with the operating system or otherwise inform the operating system of the data access interface used by the application. An application can have a definition identifier of the standard definition used by the application to store and access information used in the application. In some embodiments, the operating system can determine whether the definition identifier associated with an application is the same as an identifier corresponding to the second preset standard definition. For example, in the event that the card view 501 is dragged to the location of an application icon 502 (e.g., a calendar application icon), the operating system determines whether the application corresponding to the application icon 502 has, or otherwise provides, a data access interface conforming to a second preset standard definition. In the event that the application has, or otherwise provides, a data access interface conforming to a second preset standard definition, then a floating layer is presented. For example, the floating layer can be presented at the location of the application icon 502. In some embodiments, a prompt message is displayed on the floating layer. The prompt message can indicate whether the application corresponding to the application icon 502 has, or otherwise provides, a data access interface conforming to a second preset standard definition. For example, the prompt message can indicate that the application corresponding to the application icon 502 can receive writing of a data entity.

In one example, the second preset standard definition can require that values include the following variables or information:

```
{
  ″sid″// card view identifier corresponding to the server
  ″service_id″// ISV service identifier
  ″ownerid″// owner of card view
  ″title″// card view title
  ″content″// content to be displayed by card view
  ″occurtime″ // time of card view creation
  ″gmtexpired″ // card view expiration time
  ″location″ // location of card view
  ″logourl″ // logo address in card view
}
```

In the event that the application does not provide a data access interface that conforms to a second preset standard definition, the process 200 then can end.

In the event that the application does provide a data access interface that conforms to a second preset standard definition, at 270, the data entity is written into the application. In some embodiments, the operating system determines whether to write the data entity into the application corresponding to the application icon 502. The operating system can determine whether to write the data entity into the application based at least in part on whether the application has, or otherwise provides, a data access interface conforming to a second preset standard definition, whether a user has provided confirmation of the write of the data entity to the application, whether the comparison results of the location of the card view 501 with the application icon 502 indicate that the location of the card view 501 matches at least in part the location of the application icon 502, the like, or any combination thereof. In the event that the user confirms the write of the data entity to the application, the data entity can be written to the application. For example, in the event that the user releases the floating layer, the operating system, in response to receiving the message (e.g., instruction) generated by the floating layer release event, determines that the user wants to write the data entity into the application. The data access interface of the application conforming to a second preset standard definition is invoked to write the data entity into the application.

For example, after the calendar app obtains the airplane ticket information corresponding to the airplane ticket card view in the Taobao app, a corresponding itinerary reminder function might be implemented by integrating the airplane ticket information. Itinerary reminders would be displayed on the calendar view.

In some embodiments, implementation of a data transfer method using an Android operating system can use the operating system interface as a bridge so long as any app provides a data access interface conforming to a second preset standard definition. A data entity can be transferred between the Taobao client app and any app by dragging the card view corresponding to the data entity.

FIG. 7 is a block diagram of an example data transfer device according to various embodiments of the present application. Device 700 can transfer data between application using a process such as process 100 of FIG. 1 or process 200 of FIG. 2.

The device 700 can include a system interface call out module 710, a data entity receiving module 720, and a data writing module 730. In some embodiments, the device 700 can include a floating layer detecting module 721, a floating layer prompting module 740, or a confirmation receiving module 750.

In some embodiments, the system interface call out module 710 can be configured to provide an interface of the operating system in response to receiving an operating system interface call out message issued by a first application. As an example, the operating system interface call out message can specifically be issued by the first application in the event that the first card view has a selected status (e.g., in the event that the first card view is selected by a user). A card view can be a view in which an object that displays a representation of a data entity is provided. For example, the card view can include an icon or other image that represents the data entity. As an example, in the event that the data entity is a plane ticket, the card view can include an image or icon on which a representation of the plane ticket (e.g., the plane ticket having a reduced size relative to an original size) is provided.

In some embodiments, the data entity receiving module 720 can be configured to receive a data entity written in by the first application invoking the data access interface conforming to a first preset standard definition. The data entity can correspond to the first card view. The data entity receiving module 720 can be further configured to provide, on the operating system interface, a second view displaying the data entity.

In some embodiments, the data writing module 730 is configured to invoke the data access interface of the second application. The data access interface of the second application can conform to a second preset standard definition. The data writing module 730 can invoke the data access interface of the second application in connection with a write of the data entity into the second application. The data writing module 730 can invoke the data access interface of the second application in response to the second view being dragged on the operating system interface to the location of an icon of a second application.

In some embodiments, an operating system can serve as a bridge for transferring data between applications. For example, a user can complete the transfer of a data entity between applications by dragging the view corresponding to the data entity.

In order to avoid writing data to one application that does not provide a data access interface with a second preset standard definition and thus causing a program run error, the data writing module 730 can detect whether the second application has provided a data access interface that conforms to the second preset standard definition in the event that the second view (e.g., second card view) is dragged on the operating system interface to the location of an icon of the second application. The data writing module 730 can detect whether the second application has provided a data access interface that conforms to the preset standard definition according to a value of a flag associated with the second application or associated with a registration of the second application with the operating system. The operating system can detect whether the second application provides a data access interface that conforms to the second preset standard definition according to relevant registration information (associated with a corresponding application) of the operating system (e.g., in specific registry entries). In the event that the second application has provided a data access interface that conforms to the second preset standard definition and the second view is dragged on the operating system interface to the location of an icon of the second application, the data access interface (of the second application) that conforms to the second preset standard definition can be invoked to write the data entity into the second application.

In some embodiments, the pattern of the second view, which is configured to display the data entity and is presented on the operating system interface, is not restricted. In some embodiments, the time at which the second view is generated is not restricted.

In some embodiments, the second view is a card view generated on the operating system interface. The data entity receiving module 720 can be configured to generate a card view on the operating system interface. For example, the data entity receiving module 720 can be configured to generate the card view such that the card view corresponds to the second view displaying the data entity. The card view can be generated directly on the operating system interface after the interface of the operating system is presented. In order to enable the user to select the time and location of the card view, the first application can, before a card view is generated on the operating system interface, create a floating layer in the event that the first card view has been selected. In some embodiments, an image is drawn, or otherwise included, on the floating layer according to the first card view. In the event that the operating system interface is presented, the floating layer can automatically float with a selected status on the operating system interface such that the floating layer can be dragged.

In some embodiments, the device 700 further includes a floating layer detecting module 721. The floating layer detecting module 721 can be configured to detect (or determine) whether the floating layer on the operating system interface has been released. The floating layer can be specifically created by the first application in response to selection of the card view. The floating layer can include an image drawn, or otherwise included, thereon by the first application according to the display pattern of the first card view. In the event that the operating system interface is presented, the floating layer can automatically float with a selected status on the operating system interface so that the floating layer can be dragged. The data entity receiving module 720 can be configured to generate a card view according to the display pattern of the floating layer at the location of the floating layer on the operating system interface in the event that the status of said floating layer changes from selected to released (as detected by said floating layer detecting module 721).

In some embodiments, the data entity receiving module 720 can be configured to present, on the operating system interface, the floating layer created by the first application in the event that the first card view is selected. The floating layer can correspond to the second view displaying the data entity. The floating layer can include an image that is drawn, or otherwise provided, by the first application according to the display pattern of the first card view. In the event that the operating system interface is presented, the floating layer automatically floats with a selected status on the operating system interface so that the floating layer can be dragged.

In some embodiments, the device 700 can further include a floating layer prompting module 740. For example, the floating layer prompting module 740 can provide an indication of whether an application provides a data access interface conforming to a second preset standard definition. The user can use the indication to determine which of the applications corresponding to icons on the operating system interface provides a data access interface conforming to a second preset standard definition, and to accurately transfer the data entity into an application that can receive the data entity. The floating layer prompting module 740 can be configured to provide (e.g., present) a floating layer on the operating system interface. For example, the floating layer prompting module 740 can be configured to provide the floating layer on the operating system interface in the event that data writing module 730 determines that the second view has been dragged on the operating system interface to the location of the icon of a second application, and the second application has provided a data access interface conforming to a second preset standard definition. The prompt information can be displayed on the floating layer. The prompt information can indicate that the second application can accept the writing of a data entity.

In some embodiments, the device 700 can further include a confirmation receiving module 750. The confirmation receiving module 750 can be configured to receive a message confirming the writing of a data entity into the second application. The data writing module 730 can be configured to, in the event that the second application is determined as providing a data access interface conforming to a second preset standard definition, and the confirmation receiving module 750 has received a message confirming the writing of a data entity into the second application, invoke the data access interface (of the second application) that conforms to a second preset standard definition to write the data entity into the second application.

FIG. 8 is a structural block diagram of a system for providing data transfer between applications according to various embodiments of the present application. System 800 transfers data between applications using a process such as process 100 of FIG. 1 or process 200 of FIG. 2.

The system 800 for data transfer includes a terminal 810 and a server 820. The system 800 can include a network 830 over which the terminal 810 and the server 820 can communicate. The terminal 810 can receive a data entity or information that can be included in a data entity. The terminal 810 can transfer a data entity between applications installed on the terminal 810. The network 830 can be a LAN, a Wide Area Network (WAN), the Internet, or the like.

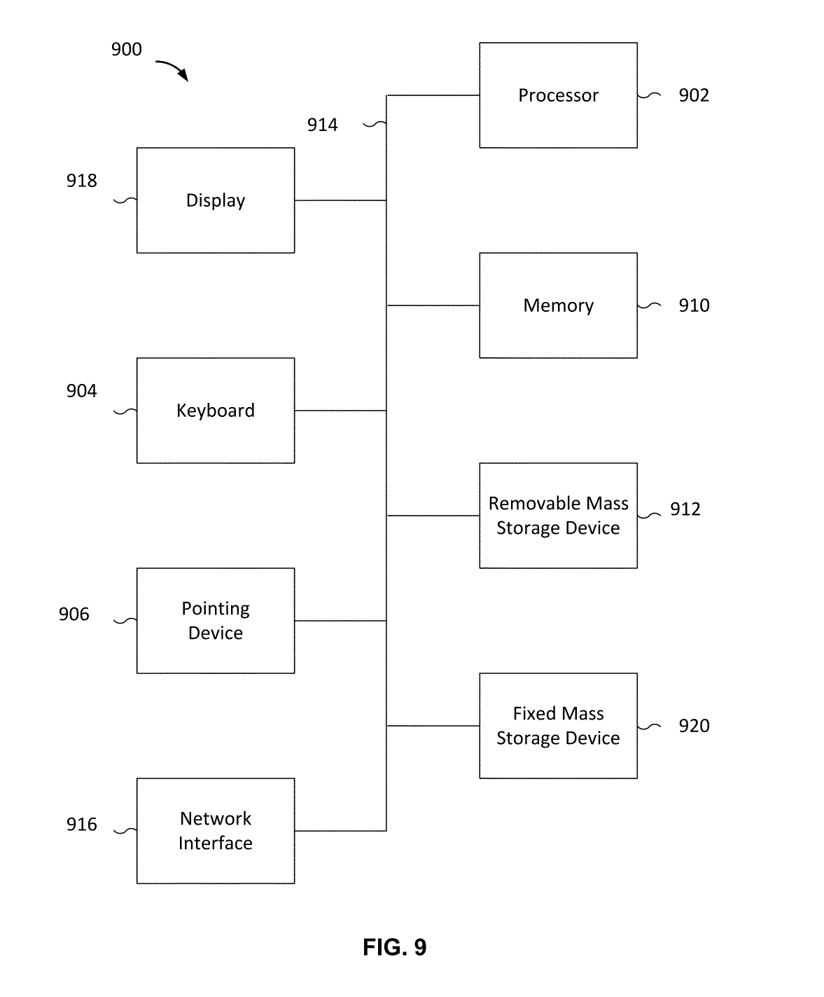

FIG. 9 is a structural block diagram of a system for providing data transfer between applications according to various embodiments of the present application.

Referring to FIG. 9, a computer system 900 for accessing a website or for determining whether a terminal accessing the website is a mobile terminal is provided. As will be apparent, other computer system architectures and configurations can be used to implement video calls. Computer system 900, which includes various subsystems as described below, includes at least one microprocessor subsystem (also referred to as a processor or a central processing unit (CPU)) 902. For example, processor 902 can be implemented by a single-chip processor or by multiple processors. In some embodiments, processor 902 is a general purpose digital processor that controls the operation of the computer system 900. Using instructions retrieved from memory 910, the processor 902 controls the reception and manipulation of input data, and the output and display of data on output devices (e.g., display 918).

Processor 902 is coupled bi-directionally with memory 910, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 902. Also as is well known in the art, primary storage typically includes basic operating instructions, program code, data, and objects used by the processor 902 to perform its functions (e.g., programmed instructions). For example, memory 910 can include any suitable computer-readable storage media, described below, depending on whether, for example, data access needs to be bi-directional or uni-directional. For example, processor 902 can also directly and very rapidly retrieve and store frequently needed data in a cache memory (not shown). The memory can be a non-transitory computer-readable storage medium.

A removable mass storage device 912 provides additional data storage capacity for the computer system 900, and is coupled either bi-directionally (read/write) or uni-directionally (read only) to processor 902. For example, storage 912 can also include computer-readable media such as magnetic tape, flash memory, PC-CARDS, portable mass storage devices, holographic storage devices, and other storage devices. A fixed mass storage 920 can also, for example, provide additional data storage capacity. The most common example of mass storage 920 is a hard disk drive. Mass storage device 912 and fixed mass storage 920 generally store additional programming instructions, data, and the like that typically are not in active use by the processor 902. It will be appreciated that the information retained within mass storage device 912 and fixed mass storage 920 can be incorporated, if needed, in standard fashion as part of memory 910 (e.g., RAM) as virtual memory.

In addition to providing processor 902 access to storage subsystems, bus 914 can also be used to provide access to other subsystems and devices. As shown, these can include a display monitor 918, a network interface 916, a keyboard 904, and a pointing device 906, as well as an auxiliary input/output device interface, a sound card, speakers, and other subsystems as needed. For example, the pointing device 906 can be a mouse, stylus, track ball, or tablet, and is useful for interacting with a graphical user interface.

The network interface 916 allows processor 902 to be coupled to another computer, computer network, or telecommunications network using a network connection as shown. For example, through the network interface 916, the processor 902 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 902 can be used to connect the computer system 900 to an external network and transfer data according to standard protocols. For example, various process embodiments disclosed herein can be executed on processor 902, or can be performed across a network such as the Internet, intranet networks, or local area networks, in conjunction with a remote processor that shares a portion of the processing. Additional mass storage devices (not shown) can also be connected to processor 902 through network interface 916.

An auxiliary I/O device interface (not shown) can be used in conjunction with computer system 900. The auxiliary I/O device interface can include general and customized interfaces that allow the processor 902 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 9 is but an example of a computer system suitable for use with the various embodiments disclosed herein. Other computer systems suitable for such use can include additional or fewer subsystems. In addition, bus 914 is illustrative of any interconnection scheme serving to link the subsystems. Other computer architectures having different configurations of subsystems can also be utilized.

The above-described are merely preferred embodiments of the present application and are not used to limit the protective scope of the present application. Any modification, equivalent substitution, or improvement made in keeping with the spirit and principles of the present application shall be included within the protective scope of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
in response to receiving an operating system interface call out message, providing an interface of an operating system running on a device;
in response to a data access interface conforming to a first preset standard definition being invoked, receiving a data entity associated with a first application installed on the device; and
in response to a data access interface of a second application being invoked, writing the data entity into the second application.

2. The method of claim 1, further comprising:
invoking, in connection with executing the first application, the data access interface conforming to the first preset standard definition; and
receiving the operating system interface call out message issued by the first application.

3. The method of claim 1, further comprising:
providing, on the operating system interface, a second card view displaying the data entity; and
in response to the second card view being dragged on the operating system interface to a location that is in proximity to an icon of the second application, invoking the data access interface of the second application, wherein the data access interface of the second application conforms to a second preset standard definition.

4. The method of claim 3, wherein the data entity corresponds to a first card view that displays a representation of information associated with the first application.

5. The method of claim 4, wherein the operating system interface call out message is issued by the first application in the event that the first card view is selected.

6. The method of claim 3, further comprising:
in the event that the second card view that is dragged on the operating system interface is to be in proximity to the location of the icon of the second application, detecting whether the second application has the data access interface that conforms to the second preset standard definition;
wherein the second data access interface is invoked in the event that the second application has the data access interface that conforms to the second preset standard definition.

7. The method of claim 3, wherein the providing, on the operating system interface, the second card view displaying the data entity comprises:
generating a card view on the operating system interface, wherein the card view includes the second card view displaying the data entity.

8. The method of claim 7, further comprising:
detecting whether a floating layer on the operating system interface has been released, wherein the floating layer is created by the first application in the event that the card view on the operating system interface has been selected, wherein the floating layer includes an image according to a display pattern associated with the data entity, wherein in the event that the operating system interface is presented, the floating layer floats on the operating system interface in the event that the floating layer is selected so that the floating layer can be dragged relative to the operating system interface;
wherein the card view on the operating system interface is generated according to the display pattern of the floating layer at a location of the floating layer on the operating system interface in response to detecting that the floating layer is released.

9. The method of claim 3, wherein the providing, on the operating system interface, of the second card view displaying the data entity comprises:
providing, on the operating system interface, a floating layer that is created by the first application in response to a first card view of the data entity being selected, wherein the floating layer corresponds to the second card view displaying the data entity, wherein the floating layer includes an image provided by the first application according to a display pattern of the first card view, and in the event that the operating system interface is provided, the floating layer is floating on said operating system interface so that the floating layer can be dragged relative to the operating system interface.

10. The method of claim 3, further comprising:
in the event that the second card view is dragged on the operating system interface to the location of the icon of the second application, and the second application has the data access interface conforming to the second preset standard definition, presenting a floating layer on the operating system interface, wherein the floating layer displays prompt information indicating that the second application supports the writing in of the data entity; and
receiving a confirmation of the writing of the data entity into the second application;
wherein the data access interface of the second application is invoked and the data entity is written into the second application in response to confirmation of the writing of the data entity into the second application.

11. The method of claim 1, wherein the operating system is an Android operating system;
wherein a data access interface is a provider interface; and
wherein the operating system interface call out message is an Intent message that calls out the operating system interface.

12. A device, the device comprising:
at least one processor configured to:
in response to receiving an operating system interface call out message, provide an interface of an operating system running on a device;
in response to a data access interface conforming to a first preset standard definition being invoked, receive a data entity associated with a first application installed on the device; and
in response to a data access interface of a second application being invoked, write the data entity into the second application; and
a memory coupled to the at least one processor and configured to provide the at least one processor with instructions.

13. The device of claim 12, wherein the at least one processor is further configured to:
invoke, in connection with executing the first application, the data access interface conforming to the first preset standard definition; and
receive the operating system interface call out message issued by the first application.

14. The device of claim 12, wherein the at least one processor is further configured to:
provide, on the operating system interface, a second card view displaying the data entity; and
in response to the second card view being dragged on the operating system interface to a location that is in proximity to an icon of the second application, invoke the data access interface of the second application, wherein the data access interface of the second application conforms to a second preset standard definition.

15. The device of claim 14, wherein the data entity corresponds to a first card view that displays a representation of information associated with the first application.

16. The device of claim 15, wherein the operating system interface call out message is issued by the first application in the event that the first card view is selected.

17. The device of claim 14, wherein the at least one processor is further configured to:
in the event that the second card view that is dragged on the operating system interface is to be in proximity to the location of the icon of the second application, detect whether the second application has the data access interface that conforms to the second preset standard definition;
wherein the second data access interface is invoked in the event that the second application has the data access interface that conforms to the second preset standard definition.

18. The device of claim 14, wherein the at least one processor is further configured to:
generate a card view on the operating system interface, wherein the card view includes the second card view displaying the data entity in connection with providing the second card view displaying the data entity on the operating system interface.

19. The device of claim 18, wherein the at least one processor is further configured to:
detect whether a floating layer on the operating system interface has been released, wherein the floating layer is created by the first application in the event that the card view on the operating system interface has been selected, wherein the floating layer includes an image according to a display pattern associated with the data entity, wherein in the event that the operating system interface is presented, the floating layer floats on the operating system interface in the event that the floating layer is selected so that the floating layer can be dragged relative to the operating system interface,
wherein the card view on the operating system interface is generated according to the display pattern of the floating layer at a location of the floating layer on the operating system interface in response to detecting that the floating layer is released.

20. The device of claim 14, wherein the at least one processor is further configured to:
provide, on the operating system interface, a floating layer that is created by the first application in response to a first card view of the data entity being selected, wherein the floating layer corresponds to the second card view displaying the data entity, wherein the floating layer includes an image provided by the first application according to a display pattern of the first card view, and in the event that the operating system interface is provided, the floating layer is floating on said operating system interface so that the floating layer can be dragged relative to the operating system interface.

21. The device of claim 14, wherein the at least one processor is further configured to:
in the event that the second card view is dragged on the operating system interface to the location of the icon of the second application, and the second application has the data access interface conforming to the second preset standard definition, present a floating layer on the operating system interface, wherein the floating layer displays prompt information indicating that the second application supports the writing in of the data entity; and
receive a confirmation of the writing of the data entity into the second application;
wherein the data access interface of the second application is invoked and the data entity is written into the second application in response to confirmation of the writing of the data entity into the second application.

22. The device of claim 12, wherein the operating system is an Android operating system;
wherein a data access interface is a provider interface; and
wherein the operating system interface call out message is an Intent message that calls out the operating system interface.

23. A computer program product, the computer program product being embodied in a non-transitory computer readable storage medium and comprising computer instructions for:
in response to receiving an operating system interface call out message, providing an interface of an operating system running on a device;
in response to a data access interface conforming to a first preset standard definition being invoked, receiving a data entity associated with a first application installed on the device; and
in response to a data access interface of a second application being invoked, writing the data entity into the second application.
